(19) United States
(12) Patent Application Publication
(10) Pub. No.: US 2025/0364769 A1
(43) Pub. Date: Nov. 27, 2025

(54) LASER CHAMBER APPARATUS, GAS LASER APPARATUS, AND ELECTRONIC DEVICE MANUFACTURING METHOD

(71) Applicant: Gigaphoton Inc., Tochigi (JP)

(72) Inventors: Noriyuki WATANABE, Oyama-shi (JP); Kazuki NAGAI, Oyama-shi (JP); Takahiro TATSUMI, Oyama-shi (JP)

(73) Assignee: Gigaphoton Inc., Tochigi (JP)

(21) Appl. No.: 19/294,259

(22) Filed: Aug. 7, 2025

Related U.S. Application Data
(63) Continuation of application No. PCT/JP2023/011314, filed on Mar. 22, 2023.

(51) Int. Cl. H01S 3/038; H01S 3/0977

(52) U.S. Cl. CPC H01S 3/0384; H01S 3/0977

(57) ABSTRACT

A laser chamber apparatus according to an aspect of the present disclosure includes a chamber, a first discharge electrode, a second discharge electrode, an electrically conductive holder configured to hold the first discharge electrode, a first dielectric pipe disposed along the first discharge electrode, a second dielectric pipe facing the first dielectric pipe and disposed along the second discharge electrode, a first preliminary ionization electrode disposed in an inner space of the first dielectric pipe, a second preliminary ionization electrode disposed in an inner space of the second dielectric pipe, a first insulating holder disposed in the electrically conductive holder and holding one-side end portions of the first dielectric pipe and the second dielectric pipe, and a second insulating holder disposed in the electrically conductive holder and holding another-side end portions of the first dielectric pipe and the second dielectric pipe.

### CROSS-REFERENCE TO RELATED APPLICATIONS

The present application is a continuation application of International Application No. PCT/JP2023/011314, filed on Mar. 22, 2023, the entire contents of which are hereby incorporated by reference.

### BACKGROUND

### 1. Technical Field

The present disclosure relates to a laser chamber apparatus, a gas laser apparatus, and an electronic device manufacturing method.

### 2. Related Art

In recent years, a semiconductor exposure apparatus is required to improve the resolution thereof as semiconductor integrated circuits are increasingly miniaturized and highly integrated. To this end, reduction in the wavelength of light emitted from a light source for exposure is underway. For example, a KrF excimer laser apparatus, which outputs laser light having a wavelength of about 248 nm, and an ArF excimer laser apparatus, which outputs laser light having a wavelength of about 193 nm, are used as a gas laser apparatus for exposure.

The light from KrF and ArF excimer laser apparatuses performing spontaneous laser oscillation has a wide spectral linewidth ranging from 350 to 400 pm. A projection lens made of a material that transmits ultraviolet light, such as KrF and ArF laser light, therefore produces chromatic aberrations in some cases. As a result, the resolution of the projection lens may decrease. To avoid the decrease in the resolution, the spectral linewidth of the laser light output from the gas laser apparatus needs to be narrow enough to make the chromatic aberrations negligible. To this end, a line narrowing module (LNM) including a line narrowing element (such as etalon or grating) is provided in some cases in a laser resonator of the gas laser apparatus to narrow the spectral linewidth. A gas laser apparatus providing a narrowed spectral linewidth is hereinafter referred to as a narrowed-line gas laser apparatus.

### CITATION LIST

### Patent Literature

PTL 1: JP-A-2012-033799
PTL 2: JP-A-2004-186310
PTL 3: JP-A-11-168254

### SUMMARY

A laser chamber apparatus according to an aspect of the present disclosure may be a laser chamber apparatus configured to generate laser light by exciting a preliminarily ionized laser gas by discharge. The laser chamber apparatus may include a chamber, a first discharge electrode, a second discharge electrode, an electrically conductive holder, a first dielectric pipe, a second dielectric pipe, a first preliminary ionization electrode, a second preliminary ionization electrode, a first insulating holder, and a second insulating holder. The chamber is configured to house a laser gas. The first discharge electrode is disposed in the chamber. The second discharge electrode is disposed in the chamber so as to face the first discharge electrode. The first discharge electrode and the second discharge electrode are configured to excite the laser gas by the discharge. The electrically conductive holder holds the first discharge electrode. The first dielectric pipe is disposed along the first discharge electrode. The second dielectric pipe faces the first dielectric pipe. The second dielectric pipe is disposed along the second discharge electrode. The first preliminary ionization electrode is disposed in an inner space of the first dielectric pipe. The second preliminary ionization electrode is disposed in an inner space of the second dielectric pipe. The first insulating holder is disposed in the electrically conductive holder. The first insulating holder holds one-side end portions of the first dielectric pipe and the second dielectric pipe. The second insulating holder is disposed in the electrically conductive holder. The second insulating holder holds another-side end portions of the first dielectric pipe and the second dielectric pipe.

A gas laser apparatus according to another aspect of the present disclosure is a gas laser apparatus that may include a laser chamber apparatus configured to generate laser light by exciting a preliminarily ionized laser gas by discharge. The laser chamber apparatus may include a chamber, a first discharge electrode, a second discharge electrode, an electrically conductive holder, a first dielectric pipe, a second dielectric pipe, a first preliminary ionization electrode, a second preliminary ionization electrode, a first insulating holder, and a second insulating holder. The chamber is configured to house a laser gas. The first discharge electrode is disposed in the chamber. The second discharge electrode is disposed in the chamber so as to face the first discharge electrode. The first discharge electrode and the second discharge electrode are configured to excite the laser gas by the discharge. The electrically conductive holder holds the first discharge electrode. The first dielectric pipe is disposed along the first discharge electrode. The second dielectric pipe faces the first dielectric pipe. The second dielectric pipe is disposed along the second discharge electrode. The first preliminary ionization electrode is disposed in an inner space of the first dielectric pipe. The second preliminary ionization electrode is disposed in an inner space of the second dielectric pipe. The first insulating holder is disposed in the electrically conductive holder. The first insulating holder holds one-side end portions of the first dielectric pipe and the second dielectric pipe. The second insulating holder is disposed in the electrically conductive holder. The second insulating holder holds another-side end portions of the first dielectric pipe and the second dielectric pipe.

An electronic device manufacturing method according to further another aspect of the present disclosure is an electronic device manufacturing method that may include: generating laser light by using a gas laser apparatus including a laser chamber apparatus; outputting the laser light to an exposure apparatus; and exposing a photosensitive substrate to the laser light in the exposure apparatus to manufacture electronic devices. The laser chamber apparatus may include a chamber, a first discharge electrode, a second discharge electrode, an electrically conductive holder, a first dielectric pipe, a second dielectric pipe, a first preliminary ionization electrode, a second preliminary ionization electrode, a first insulating holder, and a second insulating holder. The chamber is configured to house a laser gas. The first discharge electrode is disposed in the chamber. The second discharge electrode is disposed in the chamber so as to face the first discharge electrode. The first discharge electrode and the second discharge electrode are configured to excite the laser gas by the discharge. The electrically conductive holder holds the first discharge electrode. The first dielectric pipe is disposed along the first discharge electrode. The second dielectric pipe faces the first dielectric pipe. The second dielectric pipe is disposed along the second discharge electrode. The first preliminary ionization electrode is disposed in an inner space of the first dielectric pipe. The second preliminary ionization electrode is disposed in an inner space of the second dielectric pipe. The first insulating holder is disposed in the electrically conductive holder. The first insulating holder holds one-side end portions of the first dielectric pipe and the second dielectric pipe. The second insulating holder is disposed in the electrically conductive holder. The second insulating holder holds another-side end portions of the first dielectric pipe and the second dielectric pipe.

### BRIEF DESCRIPTION OF DRAWINGS

Embodiments of the present disclosure will be described below only by way of example with reference to the accompanying drawings.

FIG. 1 is a side view schematically showing the configuration of a gas laser apparatus according to Comparative Example.

FIG. 2 is a cross-sectional view showing the configuration of a laser chamber apparatus according to Comparative Example.

FIG. 3 shows the laser chamber apparatus according to Comparative Example viewed from an output coupling mirror side.

FIG. 4 shows the laser chamber apparatus according to Comparative Example viewed from a line narrowing module side.

FIG. 5 is a circuit diagram schematically showing the configurations of a PPM and a preliminary ionization discharge section.

FIG. 6 is a descriptive diagram of a problem with Comparative Example.

FIG. 7 is a side view schematically showing the configuration of a gas laser apparatus according to a first embodiment.

FIG. 8 is a cross-sectional view showing the configuration of a laser chamber apparatus according to the first embodiment.

FIG. 9 shows the laser chamber apparatus according to the first embodiment viewed from the output coupling mirror side.

FIG. 10 shows the laser chamber apparatus according to the first embodiment viewed from the line narrowing module side.

FIG. 11 is a perspective view of a first insulating holder viewed from one side thereof.

FIG. 12 is a perspective view of the first insulating holder viewed from the other side thereof.

FIG. 13 shows that a ground plate according to the first embodiment is connected to a pair of electrically conductive holding frames.

FIG. 14 is a cross-sectional view showing the configuration of a laser chamber apparatus according to a first variation of the first embodiment.

FIG. 15 shows the laser chamber apparatus according to the first variation of the first embodiment viewed from the output coupling mirror side.

FIG. 16 shows the laser chamber apparatus according to the first variation of the first embodiment viewed from the line narrowing module side.

FIG. 17 shows a laser chamber apparatus according to a second variation of the first embodiment viewed from the output coupling mirror side.

FIG. 18 shows the laser chamber apparatus according to the second variation of the first embodiment viewed from the line narrowing module side.

FIG. 19 is a cross-sectional view showing the configuration of a laser chamber apparatus according to a second embodiment.

FIG. 20 shows the laser chamber apparatus according to the second embodiment viewed from the output coupling mirror side.

FIG. 21 shows the laser chamber apparatus according to the second embodiment viewed from the line narrowing module side.

FIG. 22 shows that a ground plate according to the second embodiment is connected to a pair of electrically conductive holding frames.

FIG. 23 is a cross-sectional view showing the configuration of a laser chamber apparatus according to a first variation of the second embodiment.

FIG. 24 shows the laser chamber apparatus according to the first variation of the second embodiment viewed from the output coupling mirror side.

FIG. 25 shows the laser chamber apparatus according to the first variation of the second embodiment viewed from the line narrowing module side.

FIG. 26 shows a laser chamber apparatus according to a second variation of the second embodiment viewed from the output coupling mirror side.

FIG. 27 shows the laser chamber apparatus according to the second variation of the second embodiment viewed from the line narrowing module side.

FIG. 28 shows abnormal discharge that may occur in the laser chamber apparatus according to the second embodiment.

FIG. 29 is a cross-sectional view showing the configuration of a laser chamber apparatus according to a third embodiment.

FIG. 30 is a cross-sectional view of a first insulating holder taken along a groove.

FIG. 31 is a cross-sectional view showing the configuration of a laser chamber apparatus according to a first variation of the third embodiment.

FIG. 32 is a perspective view showing the configuration of the first insulating holder according to the first variation of the third embodiment.

FIG. 33 is a cross-sectional view showing the configuration of a laser chamber apparatus according to a second variation of the third embodiment.

FIG. 34 is a perspective view showing the configuration of a cover.

FIG. 35 is a cross-sectional view showing a portion of the first insulating holder.

FIG. 36 is a cross-sectional view showing a portion of the first insulating holder.

FIG. 37 schematically shows an example of the configuration of an exposure apparatus.

### DETAILED DESCRIPTION

### Contents

1. Comparative Example
1.1 Gas laser apparatus
1.1.1 Configuration
1.1.2 Operation
1.2 PPM and preliminary ionization discharge section
1.2.1 Configuration
1.2.2 Operation
1.3 Problems
2. First Embodiment
2.1 Configuration and operation
2.2 Advantages
2.3 Variations
2.3.1 First variation
2.3.2 Second variation
3. Second Embodiment
3.1 Configuration and operation
3.2 Advantages
3.3 Variations
3.3.1 First variation
3.3.2 Second variation
4. Third Embodiment
4.1 Configuration and operation
4.2 Advantages
4.3 Variations
4.3.1 First variation
4.3.2 Second variation
4.3.3 Third variation
5. Other variations
6. Electronic device manufacturing method

Embodiments of the present disclosure will be described below in detail with reference to the drawings. The embodiments described below show some examples of the present disclosure and are not intended to limit the contents of the present disclosure.

Furthermore, all configurations and operations described in the embodiments are not necessarily essential as configurations and operations in the present disclosure. Note that the same element has the same reference character, and no duplicate description of the same element will be made.

### 1. COMPARATIVE EXAMPLE

Comparative Example of the present disclosure will first be described. Comparative Example of the present disclosure is an aspect that the applicant is aware of as known only by the applicant, and is not a publicly known example that the applicant is self-aware of.

### 1.1 Gas Laser Apparatus

### 1.1.1 Configuration

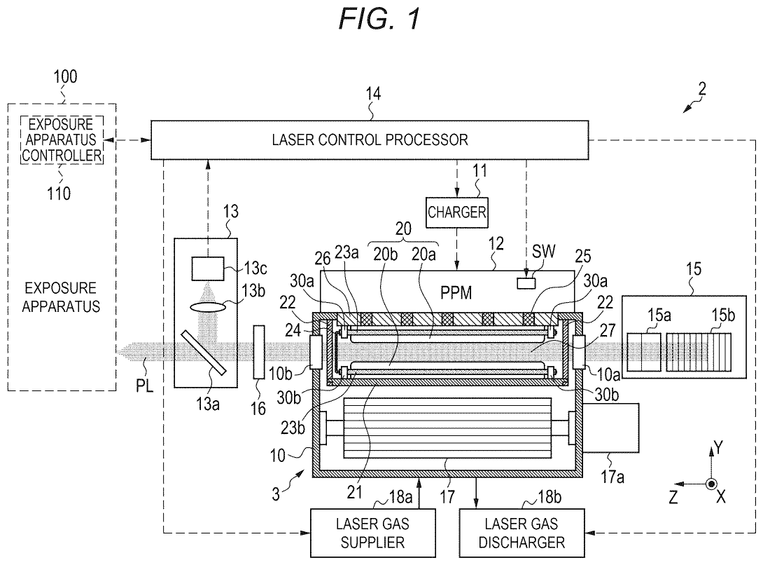

The configuration of a gas laser apparatus 2 according to Comparative Example will be described with reference to FIG. 1. FIG. 1 is a side view schematically showing the configuration of the gas laser apparatus 2. The gas laser apparatus 2 is a discharge-excitation gas laser apparatus that excites a laser gas by discharge, and is, for example, an excimer laser apparatus.

It is assumed in FIG. 1 that a traveling direction of pulse laser light PL output from the gas laser apparatus 2 is a Z direction. It is further assumed that a discharge direction that will be described later is a Y direction. It is further assumed that a direction orthogonal to the Z and Y directions is an X direction. Note that the pulse laser light PL is an example of “laser light” according to the technology of the present disclosure.

In FIG. 1, the gas laser apparatus 2 includes a laser chamber apparatus 3, a charger 11, a pulse power module (PPM) 12, a pulse energy measuring unit 13, a laser control processor 14, and a laser resonator. The laser resonator is configured with a line narrowing module 15 and an output coupling mirror 16.

The laser chamber apparatus 3 includes a chamber 10. The chamber 10 is, for example, a metal container made of aluminum and having surfaces plated with nickel. The chamber 10 accommodates a primary discharge section 20, a ground plate 21, a pair of electrically conductive holding frames 22, a first dielectric pipe 23a, a second dielectric pipe 23b, a preliminary ionization inner electrode 24, and a preliminary ionization outer electrode that will be described later.

The chamber 10 houses a laser gas containing fluorine. The laser gas includes, for example, argon, krypton, xenon, or any other element as a rare gas, neon, helium, or any other element as a buffer gas, and fluorine, chlorine, or any other element as a halogen gas.

The chamber 10 further has an opening. An electrically insulating plate 26, in which feedthroughs 25 are embedded, is attached to the chamber 10 via an O-ring that is not shown so as to close the opening. The PPM 12 is disposed on the electrically insulating plate 26. The chamber 10 is grounded.

The PPM 12 includes a charging capacitor C₀, which will be described later, and is connected to the primary discharge section 20 via the feedthroughs 25. The PPM 12 includes a switch SW, which causes the primary discharge section 20 to perform discharge. The charger 11 is connected to the charging capacitor C₀ in the PPM 12. Glow discharge that occurs at the primary discharge section 20 is hereinafter referred to as primary discharge.

The primary discharge section 20 is configured with a cathode 20a and an anode 20b. The cathode 20a and the anode 20b each extend in the Z direction. The anode 20b is disposed in the chamber 10. The cathode 20a is disposed in the chamber 10 so as to face the anode 20b. The cathode 20a and the anode 20b excite the laser gas by discharge. The space between a discharge surface of the cathode 20a and a discharge surface of the anode 20b is called a discharge space 27. Note that the anode 20b is an example of the “first discharge electrode” according to the technology of the present disclosure, and the cathode 20a is an example of the “second discharge electrode” according to the technology of the present disclosure.

The surface of the cathode 20a that is opposite to the discharge surface is held by the electrically insulating plate 26, and is connected to the feedthroughs 25. The surface of the anode 20b that is opposite to the discharge surface is held by the ground plate 21.

The ground plate 21 is connected to the chamber 10 via the pair of electrically conductive holding frames 22. One of the pair of electrically conductive holding frames 22 is connected to one end of the ground plate 21, and the other of the pair of electrically conductive holding frames 22 is connected to the other end of the ground plate 21. The chamber 10 is grounded. The ground plate 21 is therefore grounded.

The first dielectric pipe 23a and the second dielectric pipe 23b extend in the Z direction. The first dielectric pipe 23a faces a side surface of the cathode 20a and is disposed along the longitudinal direction of the cathode 20a. The second dielectric pipe 23b faces a side surface of the anode 20b and is disposed along the anode 20b. The preliminary ionization inner electrode 24 is inserted into the inner space of the first dielectric pipe 23a and the inner space of the second dielectric pipe 23b. The first dielectric pipe 23a and the second dielectric pipe 23b generate ultraviolet light that preliminarily ionizes the laser gas.

The first dielectric pipe 23a is attached to the electrically insulating plate 26 via a pair of first dielectric pipe holding sections 30a. One of the pair of first dielectric pipe holding sections 30a holds one end of the first dielectric pipe 23a, and the other of the pair of first dielectric pipe holding sections 30a holds the other end of the first dielectric pipe 23a.

The second dielectric pipe 23b is attached to the ground plate 21 via a pair of second dielectric pipe holding sections 30b. One of the pair of second dielectric pipe holding sections 30b holds one end of the second dielectric pipe 23b, and the other of the pair of second dielectric pipe holding sections 30b holds the other end of the second dielectric pipe 23b.

A fan 17 is a crossflow fan used to circulate the laser gas in the chamber 10, and is disposed on the side opposite to the discharge space 27 with the ground plate 21 disposed therebetween. A motor 17a, which rotationally drives the fan 17, is connected to the chamber 10. The laser gas blown out from the fan 17 flows into the discharge space 27. A flowing direction of the laser gas flowing into the discharge space 27 is substantially parallel to the X direction. The laser gas flowing out of the discharge space 27 is suctioned into the fan 17 via a heat exchanger that is not shown.

A laser gas supplier 18a and a laser gas discharger 18b are connected to the chamber 10. The laser gas supplier 18a includes a valve and a flow rate control valve, and is connected to a gas cylinder containing the laser gas. The laser gas discharger 18b includes a valve and a discharge pump.

Windows 10a and 10b are provided at end portions of the chamber 10 to cause light generated in the chamber 10 to exit out thereof. The chamber 10 is so disposed that the optical path of the optical resonator passes through the discharge space 27 and the windows 10a and 10b.

The line narrowing module 15 includes a prism 15a and a grating 15b. The prism 15a increases the beam width of the light output from the chamber 10 via the window 10a, and transmits the light toward the grating 15b.

The grating 15b is disposed in the Littrow arrangement, which causes the angle of incidence of the light incident on the grating 15b to be equal to the angle of diffraction of the light diffracted by the grating 15b. The grating 15b is a wavelength selector that selectively extracts light having a specific wavelength and wavelengths in the vicinity thereof in accordance with the angle of diffraction. The light that returns from the grating 15b to the chamber 10 via the prism 15a has a narrowed spectral width.

The output coupling mirror 16 transmits part of the light output from the chamber 10 via the window 10b and reflects the other part of the light back into the chamber 10. The surfaces of the output coupling mirror 16 are each coated with a partially reflective film.

The light output from the chamber 10 travels back and forth between the line narrowing module 15 and the output coupling mirror 16 and is amplified whenever passing through the discharge space 27. Part of the amplified light is output as the pulse laser light PL via the output coupling mirror 16.

The pulse energy measuring unit 13 is disposed in the optical path of the pulse laser light PL output via the output coupling mirror 16. The pulse energy measuring unit 13 includes a beam splitter 13a, a light collection optical system 13b, and a photosensor 13c.

The beam splitter 13a transmits the pulse laser light PL at high transmittance and reflects part of the pulse laser light PL toward the light collection optical system 13b. The light collection optical system 13b collects the light reflected off the beam splitter 13a at the light receiving surface of the photosensor 13c. The photosensor 13c measures the pulse energy of the light collected at the light receiving surface, and outputs the measured value to the laser control processor 14.

The charger 11 is a high-voltage power supply that supplies a charging voltage to the charging capacitor C₀ incorporated in the PPM 12. The switch SW in the PPM 12 is controlled by the laser control processor 14. When the switch SW is turned on from the state in which the switch SW is off, the PPM 12 generates high voltage pulses from the electrical energy stored in the charging capacitor C₀ and applies the pulses to the primary discharge section 20.

The laser control processor 14 is a processing device including a storage device that stores a control program and a CPU (central processing unit) that executes the control program. The laser control processor 14 transmits and receives various signals to and from an exposure apparatus controller 110 provided in an exposure apparatus 100. For example, target pulse energy of the pulse laser light PL to be output to the exposure apparatus 100, an oscillation trigger signal, and other factors are transmitted from the exposure apparatus controller 110 to the laser control processor 14. The laser control processor 14 harmoniously controls the operation of each of the elements of the gas laser apparatus 2 based on the various signals transmitted from the exposure apparatus controller 110, the measured value of the pulse energy, and other pieces of information.

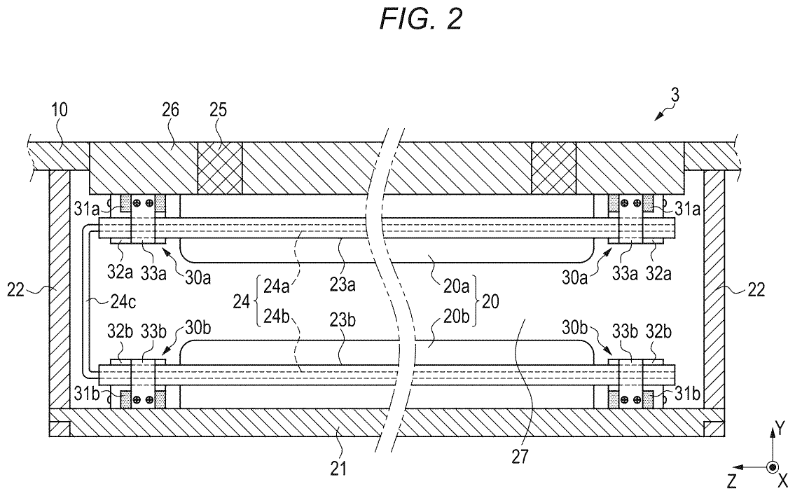

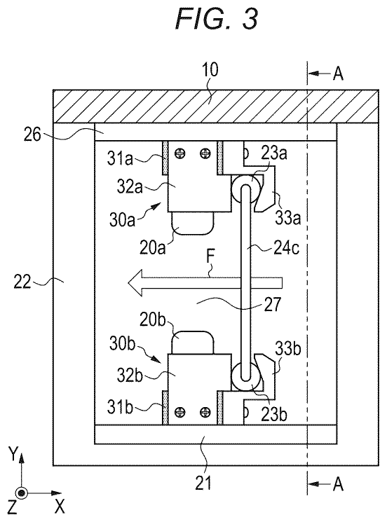

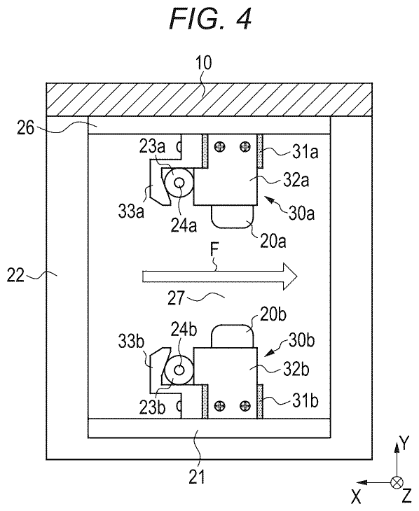

The configurations of the first dielectric pipe holding sections 30a and the second dielectric pipe holding sections 30b will next be described with reference to FIGS. 2 to 4. FIG. 2 is a cross-sectional view showing the configuration of the laser chamber apparatus 3 according to Comparative Example. FIG. 3 shows the laser chamber apparatus 3 according to Comparative Example viewed from the output coupling mirror 16 side. FIG. 4 shows the laser chamber apparatus 3 according to Comparative Example viewed from the line narrowing module 15 side. Note that FIG. 2 shows the cross-section taken along the line A-A in FIG. 3. An arrow F shown in FIGS. 3 and 4 indicates the direction in which the laser gas flows.

The first dielectric pipe 23a is disposed upstream from the cathode 20a along the flow of the laser gas. The second dielectric pipe 23b is disposed upstream from the anode 20b along the flow of the laser gas.

The pair of first dielectric pipe holding sections 30a each include a base member 31a, a first member 32a, and a second member 33a. For example, the base member 31a is made of metal, and the first member 32a and the second member 33a are insulating. The base member 31a is fixed to the electrically insulating plate 26. The first member 32a and the second member 33a are fixed to the base member 31a with screws with the first dielectric pipe 23a sandwiched therebetween.

The pair of second dielectric pipe holding sections 30b each include a base member 31b, a first member 32b, and a second member 33b. For example, the base member 31b is made of metal, and the first member 32b and the second member 33b are insulating. The base member 31b is fixed to the ground plate 21. The first member 32b and the second member 33b are fixed to the base member 31b with screws with the second dielectric pipe 23b sandwiched therebetween.

The preliminary ionization inner electrode 24 includes a first preliminary ionization electrode 24a and a second preliminary ionization electrode 24b. The first preliminary ionization electrode 24a extends in the Z direction and is disposed in the inner space of the first dielectric pipe 23a. The second preliminary ionization electrode 24b extends in the Z direction and is disposed in the inner space of the second dielectric pipe 23b. The first preliminary ionization electrode 24a and the second preliminary ionization electrode 24b are connected to each other at the ends located on the same side. A portion 24c, where the two preliminary ionization electrodes are connected to each other, extends in the Y direction. In Comparative Example, the first preliminary ionization electrode 24a and the second preliminary ionization electrode 24b are configured with a U-shaped unitary electrically conductive member.

### 1.1.2 Operation

The operation of the gas laser apparatus 2 according to Comparative Example will next be described. The laser control processor 14 first controls the laser gas supplier 18a to cause it to supply the laser gas into the chamber 10, and drives the motor 17a to rotate the fan 17. The laser gas in the chamber 10 thus circulates.

Upon receiving the target pulse energy from the exposure apparatus controller 110, the laser control processor 14 sets a charging voltage according to the received target pulse energy in the charger 11. Thereafter, upon receiving the oscillation trigger signal from the exposure apparatus controller 110, the laser control processor 14 operates the switch SW in the PPM 12.

When the switch SW in the PPM 12 is turned on from the state in which the switch SW is off, voltages are applied to the space between the preliminary ionization inner electrode 24 and the preliminary ionization outer electrode, and to the space between the cathode 20a and the anode 20b. Corona discharge thus occurs between the preliminary ionization inner electrode 24 and the preliminary ionization outer electrode, so that ultraviolet light is generated. Irradiating the laser gas in the discharge space 27 with the ultraviolet light preliminarily ionizes the laser gas.

Thereafter, when the voltage between the cathode 20a and the anode 20b reaches the dielectric breakdown voltage, the primary discharge occurs in the discharge space 27. When the primary discharge occurs, the laser gas in the discharge space 27 is excited and generates excimer. Light is emitted when the generated excimer transitions from the excited state to the ground state.

The light emitted from the laser gas is reflected off the line narrowing module 15 and the output coupling mirror 16 and therefore travels back and forth in the laser resonator, so that laser oscillation occurs. The light having a bandwidth narrowed by the line narrowing module 15 is output as the pulse laser light PL via the output coupling mirror 16. The pulse laser light PL output via the output coupling mirror 16 is output toward the exposure apparatus 100.

Part of the pulse laser light PL output via the output coupling mirror 16 enters the pulse energy measuring unit 13. The pulse energy measuring unit 13 measures the pulse energy of the incident pulse laser light PL, and outputs the measured value to the laser control processor 14.

The laser control processor 14 calculates a difference between the measured pulse energy and the target pulse energy. The laser control processor 14 performs feedback control on the charging voltage based on the calculated difference in such a way that the measured pulse energy becomes the target pulse energy.

### 1.2 PPM and Preliminary Ionization Discharge Section

### 1.2.1 Configuration

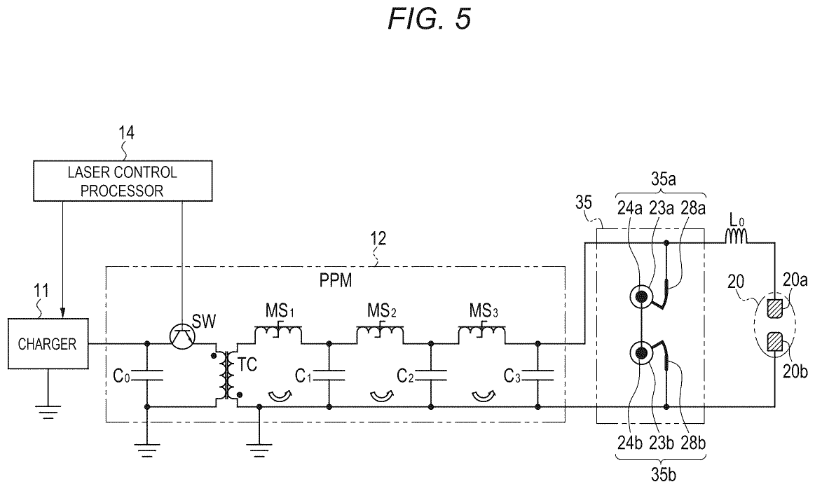

The configurations of the PPM 12 and a preliminary ionization discharge section 35 will be described with reference to FIG. 5. FIG. 5 is a circuit diagram schematically showing the configurations of the PPM 12 and the preliminary ionization discharge section 35.

The PPM 12 includes the switch SW, a transformer TC, magnetic switches MS₁, MS₂, and MS₃, the charging capacitor C₀, and capacitors C₁, C₂, and C₃. The switch SW is provided between the charging capacitor C₀ and the primary side of the transformer TC. The switch SW is a semiconductor switching device, for example, an insulated gate bipolar transistor (IGBT).

The magnetic switch MS₁ is provided between the secondary side of the transformer TC and the capacitor C₁. The magnetic switch MS₂ is provided between the capacitor C₁ and the capacitor C₂. The magnetic switch MS₃ is provided between the capacitor C₂ and the capacitor C₃. The primary side and the secondary side the transformer TC are electrically isolated from each other. In the transformer TC, the primary-side and secondary-side windings are wound in opposite directions.

The primary discharge section 20 and the preliminary ionization discharge section 35 are connected in parallel to the PPM 12. The preliminary ionization discharge section 35 includes a first preliminary ionization discharge section 35a and a second preliminary ionization discharge section 35b. The first preliminary ionization discharge section 35a and the second preliminary ionization discharge section 35b are connected in series between the cathode 20a and the anode 20b. The first preliminary ionization discharge section 35a includes the first dielectric pipe 23a, the first preliminary ionization electrode 24a, and a first preliminary ionization outer electrode 28a. The second preliminary ionization discharge section 35b includes the second dielectric pipe 23b, the second preliminary ionization electrode 24b, and a second preliminary ionization outer electrode 28b.

The first preliminary ionization outer electrode 28a and the second preliminary ionization outer electrode 28b constitute the preliminary ionization outer electrode described above. The first preliminary ionization outer electrode 28a is connected to the cathode 20a via an inductance L₀. The second preliminary ionization outer electrode 28b is electrically connected to the anode 20b. The first preliminary ionization outer electrode 28a is juxtaposed to the first dielectric pipe 23a. The second preliminary ionization outer electrode 28b is juxtaposed to the second dielectric pipe 23b.

### 1.2.2 Operation

The operations of the charger 11 and the PPM 12 will next be described. The charger 11 has a charging voltage set by the laser control processor 14, and charges the charging capacitor C₀ based on the set charging voltage.

In the PPM 12, when a control signal is transmitted from the laser control processor 14 to the switch SW, the switch SW is closed, and a current flows from the charging capacitor C₀ to the primary side of the transformer TC.

In the transformer TC, the current flows to the primary side of the transformer TC, so that electromagnetic induction causes a current to flow in the opposite direction on the secondary side of the transformer TC. An electromotive force generated by the current flowing on the secondary side of the transformer TC closes the magnetic switch MS₁, so that the current flows from the secondary side of the transformer TC to the capacitor C₁. The capacitor C₁ is thus charged.

When the capacitor C₁ is charged, the magnetic switch MS₂ is closed, so that a current flows from the capacitor C₁ to the capacitor C₂. The capacitor C₂ is thus charged. In this process, the capacitor C₂ is charged with a current having a pulse width shorter than the pulse width of the current used to charge the capacitor C₁.

When the capacitor C₂ is charged, the magnetic switch MS₃ is closed, so that a current flows from the capacitor C₂ to the capacitor C₃. The capacitor C₃ is thus charged. In this process, the capacitor C₃ is charged with a current having a pulse width shorter than the pulse width of the current used to charge the capacitor C₂.

As described above, the current flows sequentially through the capacitor C₁, the capacitor C₂, and the capacitor C₃, so that the pulse width of the current is compressed, and charge is charged in the capacitor C₃.

A voltage is then applied from the capacitor C₃ to the preliminary ionization discharge section 35. The voltage applied to the preliminary ionization discharge section 35 is divided into two, which are applied to the first preliminary ionization discharge section 35a and the second preliminary ionization discharge section 35b. Corona discharge thus occurs at each of the first preliminary ionization discharge section 35a and the second preliminary ionization discharge section 35b, so that ultraviolet light is generated. When the capacitor C₃ then applies the voltage to the primary discharge section 20, the primary discharge occurs.

### 1.3 Problems

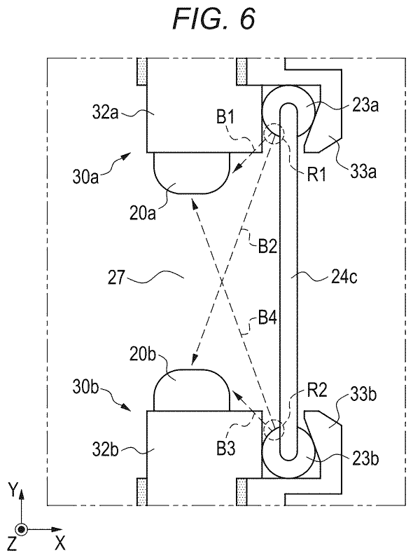

In the laser chamber apparatus 3 according to Comparative Example, the first dielectric pipe 23a and the second dielectric pipe 23b are juxtaposed to the cathode 20a and the anode 20b, respectively, as shown in FIG. 6. Ultraviolet light generated in an ultraviolet light generation region R1 of the first dielectric pipe 23a is radiated onto the surface of the cathode 20a adjacent to the region R1 as indicated by an arrow B1, and also radiated onto the surface of the anode 20b, which obliquely faces the region R1 as indicated by an arrow B2. Similarly, ultraviolet light generated in an ultraviolet light generation region R2 of the second dielectric pipe 23b is radiated onto the surface of the anode 20b adjacent to the region R2 as indicated by an arrow B3, and also radiated onto the surface of the cathode 20a, which obliquely faces the region R2 as indicated by an arrow B4.

When the distance between the first dielectric pipe 23a and the cathode 20a is short, the amount of light blocked by the side surface of the cathode 20a out of the ultraviolet light indicated by the arrow B1 increases. Similarly, when the distance between the second dielectric pipe 23b and the anode 20b is short, the amount of light blocked by the side surface of the anode 20b out of the ultraviolet light indicated by the arrow B3 increases. To suppress the amount of light blocked by the side surfaces of the electrodes adjacent to the ultraviolet light generation regions, the first dielectric pipe 23a and the second dielectric pipe 23b need to be disposed at a certain distance from the cathode 20a and the anode 20b, respectively.

The first dielectric pipe 23a is held by the pair of first dielectric pipe holding sections 30a, and is therefore disposed at a certain distance from the cathode 20a. The second dielectric pipe 23b is held by the pair of second dielectric pipe holding sections 30b, and is therefore disposed at a certain distance from the anode 20b.

However, the pair of first dielectric pipe holding sections 30a and the pair of second dielectric pipe holding sections 30b are each configured with multiple parts, and even when the same parts have the same shape, the dimensions thereof vary within tolerances, so that there are positional shifts according to the number of the parts. Specifically, the first dielectric pipe 23a is held by six parts that constitute the pair of first dielectric pipe holding sections 30a. The second dielectric pipe 23b is held by six parts that constitute the pair of second dielectric pipe holding sections 30b. The first dielectric pipe holding sections 30a and the second dielectric pipe holding sections 30b are therefore each positionally shifted due to the tolerances of the six parts.

In particular, an increase in the number of parts increases the positional shift between the cathode 20a and the ultraviolet light generation region R2 obliquely facing the cathode 20a and the positional shift between the anode 20b and the ultraviolet light generation region R1 obliquely facing the anode 20b. The positional shifts described above increase as the distance between the cathode 20a and the second dielectric pipe 23b and the distance between the anode 20b and the first dielectric pipe 23a increase. When the positional shifts described above increase, the uniformity of the amount of the ultraviolet light with which the discharge space 27 is irradiated decreases, so that the preliminary ionization of the laser gas varies, and the intensity distribution characteristics of the pulse laser light PL therefore deteriorate.

To solve the problem described above, it is required to precisely position the first dielectric pipe 23a and the second dielectric pipe 23b with respect to the cathode 20a and the anode 20b.

### 2. FIRST EMBODIMENT

### 2.1 Configuration and Operation

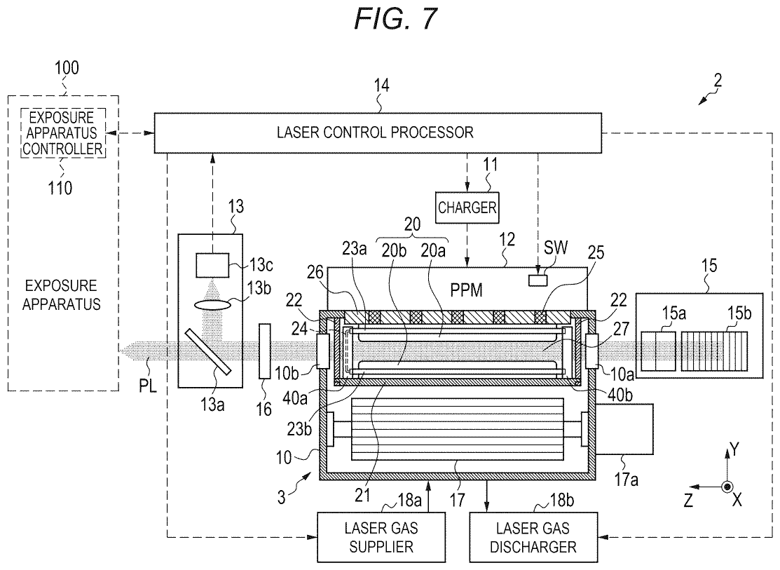

A first embodiment of the present disclosure will be described. FIG. 7 is a side view schematically showing the configuration of a gas laser apparatus 2 according to the first embodiment. The gas laser apparatus 2 according to the present embodiment is configured in the same manner as the gas laser apparatus 2 according to Comparative Example except the laser chamber apparatus 3 is configured differently.

A laser chamber apparatus 3 according to the present embodiment includes a first insulating holder 40a and a second insulating holder 40b in place of the pair of first dielectric pipe holding sections 30a and the pair of second dielectric pipe holding sections 30b. Other configurations of the laser chamber apparatus 3 according to the present embodiment are the same as those of the laser chamber apparatus 3 according to Comparative Example.

The first insulating holder 40a holds one end portion of each of the first dielectric pipe 23a and the second dielectric pipe 23b. The second insulating holder 40b holds the other end portion of each of the first dielectric pipe 23a and the second dielectric pipe 23b. In the present embodiment, the first insulating holder 40a and the second insulating holder 40b are disposed on the ground plate 21. Note in the present embodiment that the ground plate 21 corresponds to the “electrically conductive holder” according to the technology of the present disclosure.

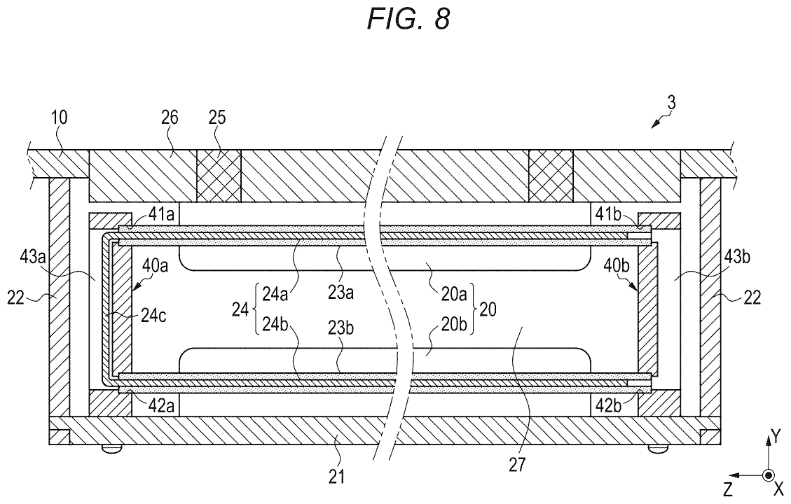

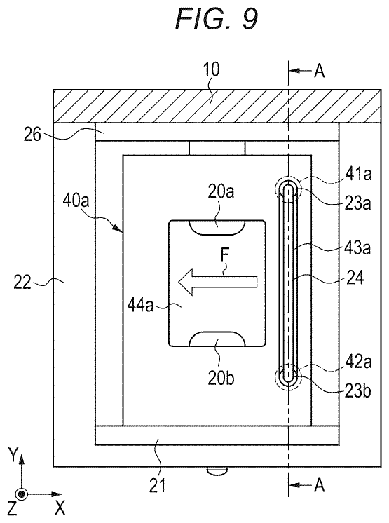

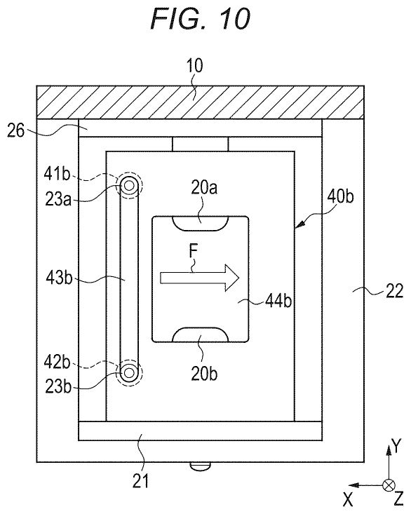

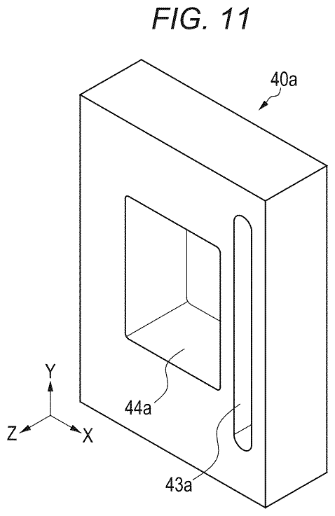

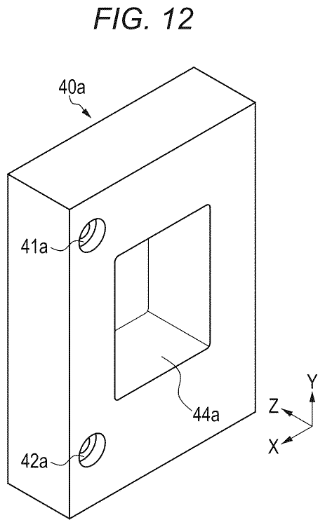

The configuration of the first insulating holder 40a and the second insulating holder 40b will next be described with reference to FIGS. 8 to 12. FIG. 8 is a cross-sectional view showing the configuration of the laser chamber apparatus 3 according to the first embodiment. FIG. 9 shows the laser chamber apparatus 3 according to the first embodiment viewed from the output coupling mirror 16 side. FIG. 10 shows the laser chamber apparatus 3 according to the first embodiment viewed from the line narrowing module 15 side. FIG. 11 is a perspective view of the first insulating holder 40a viewed from one side thereof. FIG. 12 is a perspective view of the first insulating holder 40a viewed from the other side thereof. Note that FIG. 8 shows the cross-section taken along the line A-A in FIG. 9.

The first insulating holder 40a has holes 41a and 42a formed at one surface thereof and a groove 43a formed at the other surface thereof, as shown in FIG. 8. The holes 41a and 42a are separate from each other in the Y direction and communicate with the groove 43a extending in the Y direction.

The second insulating holder 40b is configured in the same manner as the first insulating holder 40a. That is, the second insulating holder 40b has holes 41b and 42b formed at one surface and a groove 43b formed at the other surface. The diameter of the holes 41a and 41b is approximately equal to the diameter of the first dielectric pipe 23a. The diameter of the holes 42a and 42b is approximately equal to the diameter of the second dielectric pipe 23b. The holes 41b and 42b are separate from each other in the Y direction and communicate with the groove 43b extending in the Y direction.

The first insulating holder 40a and the second insulating holder 40b are each a block-shaped unitary structure, that is, a single part. For example, the first insulating holder 40a and the second insulating holder 40b are each a machined unitary structure. The first insulating holder 40a and the second insulating holder 40b are preferably made of a highly insulating material that hardly reacts with fluorine, and are preferably made, for example, of a ceramic material such as alumina and zirconium oxide.

One end of the first dielectric pipe 23a is fitted into the hole 41a of the first insulating holder 40a, and the other end of the first dielectric pipe 23a is fitted into the hole 41b of the second insulating holder 40b. One end of the second dielectric pipe 23b is fitted into the hole 42a of the first insulating holder 40a, and the other end of the second dielectric pipe 23b is fitted into the hole 42b of the second insulating holder 40b. The first dielectric pipe 23a and the second dielectric pipe 23b are preferably made of a highly insulating material that hardly reacts with fluorine, and are preferably made, for example, of a ceramic material such as alumina, or sapphire.

A step is formed in each of the holes of the first insulating holder 40a and the second insulating holder 40b, and the first dielectric pipe 23a and the second dielectric pipe 23b are positioned in the Z direction when the end surfaces of the dielectric pipes come into contact with the steps.

A portion of the preliminary ionization inner electrode 24, that is, the portion 24c, where the first preliminary ionization electrode 24a and the second preliminary ionization electrode 24b are connected to each other and which extends in the Y direction, is inserted into the groove 43a of the first insulating holder 40a. Note in the present embodiment that the groove 43b is formed in the second insulating holder 40b because the second insulating holder 40b is configured in the same manner as the first insulating holder 40a, but the groove 43b may not be formed. That is, the holes 41b and 42b only need to be formed in the second insulating holder 40b.

An opening 44a, through which the pulse laser light PL passes, is formed in the first insulating holder 40a, as shown in FIG. 9. An opening 44b, through which the pulse laser light PL passes, is formed in the second insulating holder 40b, as shown in FIG. 10. The first dielectric pipe 23a and the second dielectric pipe 23b are disposed upstream from the cathode 20a and the anode 20b along the flow of the laser gas as in Comparative Example. Note that the first dielectric pipe 23a and the second dielectric pipe 23b may be disposed downstream from the cathode 20a and the anode 20b along the flow of the laser gas.

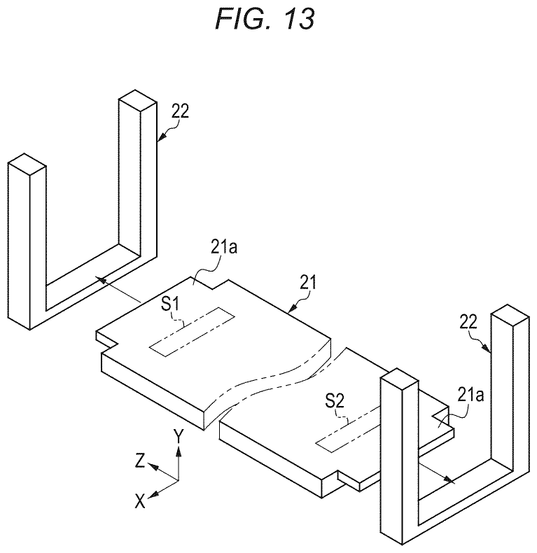

FIG. 13 shows that the ground plate 21 according to the first embodiment is connected to the pair of electrically conductive holding frames 22. The ground plate 21 extends in the Z direction, which is a longitudinal direction of the cathode 20a and the anode 20b, and protrusions 21a are provided at both ends of the ground plate 21 in the direction in which it extends. The ground plate 21 is connected to the pair of electrically conductive holding frames 22 via the pair of protrusions 21a.

The first insulating holder 40a and the second insulating holder 40b are disposed at both end portions of the ground plate 21 in the direction in which it extends. In FIG. 13, a placement region S1 indicates the region where the first insulating holder 40a is disposed, and a placement region S2 indicates the region where the second insulating holder 40b is disposed. The first insulating holder 40a and the second insulating holder 40b are each fixed to the ground plate 21 with screws.

The operation of the gas laser apparatus 2 according to the present embodiment is the same as the operation of the gas laser apparatus 2 according to Comparative Example.

### 2.2 Advantages

According to the present embodiment, the first dielectric pipe 23a and the second dielectric pipe 23b are held by the first insulating holder 40a and the second insulating holder 40b, respectively. The configuration requires only a small number of parts, so that the positional shift described above due to tolerances can be suppressed. Therefore, according to the present embodiment, the first dielectric pipe 23a and the second dielectric pipe 23b can precisely be positioned with respect to the cathode 20a and the anode 20b.

The configuration in the present embodiment suppresses the positional shift between the cathode 20a and the ultraviolet light generation region obliquely facing the cathode 20a and the positional shift between the anode 20b and the ultraviolet light generation region obliquely facing the anode 20b. As a result, the uniformity of the amount of the ultraviolet light with which the discharge space 27 is irradiated is improved, so that the variation in the preliminary ionization of the laser gas is suppressed, and the intensity distribution characteristics of the pulse laser light PL are improved.

In Comparative Example, the first dielectric pipe 23a and the second dielectric pipe 23b are in line-contact with and are held by the pair of first dielectric pipe holding sections 30a and the pair of second dielectric pipe holding sections 30b. In contrast, in the present embodiment, the first dielectric pipe 23a and the second dielectric pipe 23b are held by the first insulating holder 40a and the second insulating holder 40b with the two dielectric pipes being in surface-contact with the holes 41a and 42a and the holes 41b and 42b of the two insulating holders. The first dielectric pipe 23a and the second dielectric pipe 23b can therefore be positioned with higher precision.

Furthermore, when the first dielectric pipe 23a and the second dielectric pipe 23b are made of the same material, have the same diameter and length, and otherwise configured in the same manner, variations in the voltages applied to the two dielectric pipes can be suppressed. The uniformity of the amount of the ultraviolet light with which the discharge space 27 is irradiated is thus improved, so that the intensity distribution characteristics of the pulse laser light PL are further improved.

### 2.3 Variations

Variations of the first embodiment will be described below. The following variations each differ from the first embodiment only in the configuration of the laser chamber apparatus 3.

### 2.3.1 First Variation

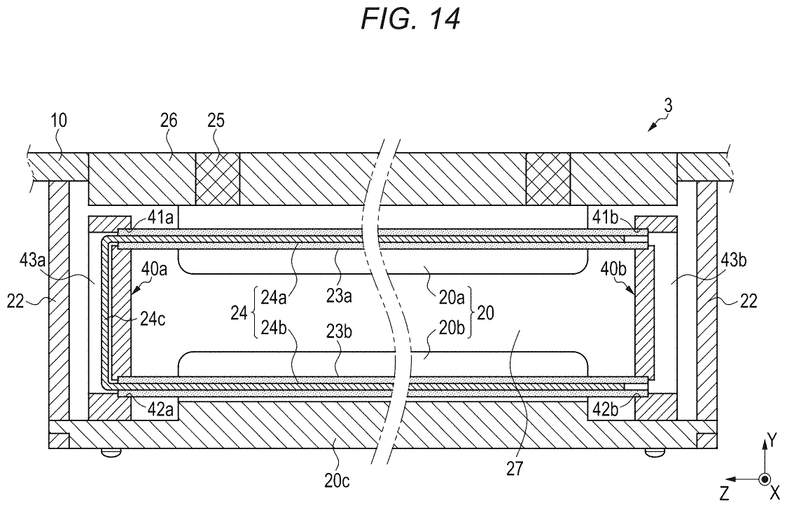

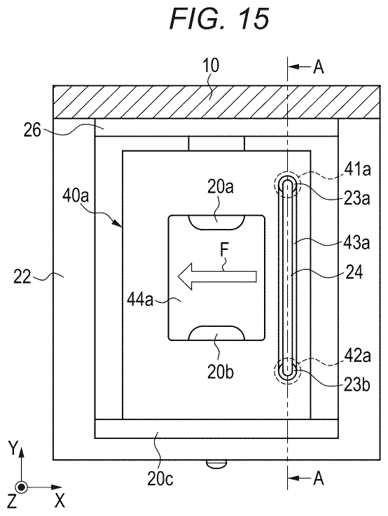

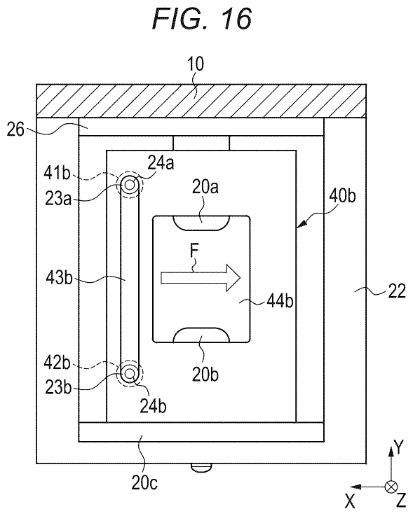

FIG. 14 is a cross-sectional view showing the configuration of a laser chamber apparatus 3 according to a first variation of the first embodiment. FIG. 15 shows the laser chamber apparatus 3 according to the first variation of the first embodiment viewed from the output coupling mirror 16 side. FIG. 16 shows the laser chamber apparatus 3 according to the first variation of the first embodiment viewed from the line narrowing module 15 side. Note that FIG. 14 shows the cross-section taken along the line A-A in FIG. 15.

In the present variation, the first insulating holder 40a and the second insulating holder 40b are provided on a base section 20c of the anode 20b. The anode 20b and the base section 20c form a single unitary structure. For example, the anode 20b and the base section 20c form a unitary structure formed by machining a metal member.

The base section 20c extends in the Z direction and is connected to the pair of electrically conductive holding frames 22 via protrusions provided at both ends in the direction in which the base section 20c extends, as the ground plate 21 in the first embodiment. The first insulating holder 40a and the second insulating holder 40b are disposed at both end portions of the base section 20c in the direction in which it extends. Note in the present variation that the base section 20c corresponds to the “electrically conductive holder” according to the technology of the present disclosure.

The laser chamber apparatus 3 according to the present variation is configured in the same manner as the laser chamber apparatus 3 according to the first embodiment except that the ground plate 21 is replaced with the base section 20c of the anode 20b.

In the present variation, since the first insulating holder 40a and the second insulating holder 40b are disposed at the base section 20c, which is integral with the anode 20b, in place of the ground plate 21, there are no dimensional errors due to the tolerances of the ground plate 21. The first dielectric pipe 23a and the second dielectric pipe 23b can therefore be positioned with higher precision, so that the intensity distribution characteristics of the pulse laser light PL are further improved.

### 2.3.2 Second Variation

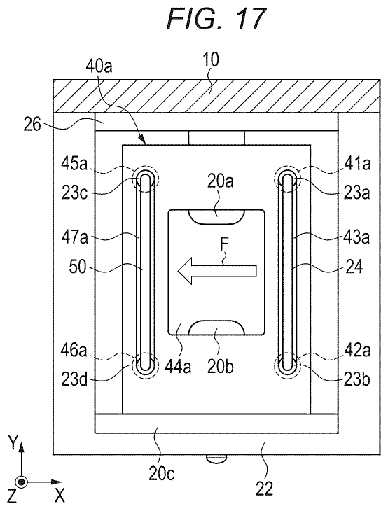

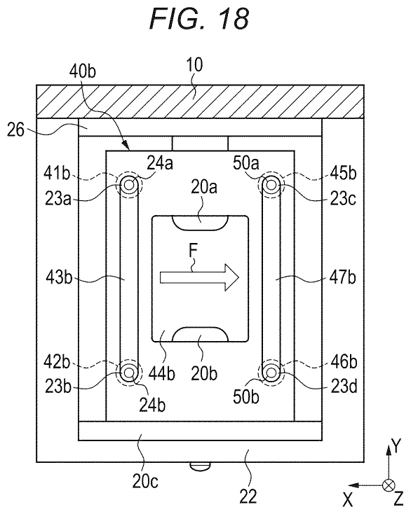

FIG. 17 shows a laser chamber apparatus 3 according to a second variation of the first embodiment viewed from the output coupling mirror 16 side. FIG. 18 shows the laser chamber apparatus 3 according to the second variation of the first embodiment viewed from the line narrowing module 15 side.

In the present variation, in addition to the first dielectric pipe 23a and the second dielectric pipe 23b, a third dielectric pipe 23c and a fourth dielectric pipe 23d are provided in the chamber 10. The third dielectric pipe 23c and the fourth dielectric pipe 23d are configured in the same manner as the first dielectric pipe 23a and the second dielectric pipe 23b, and are juxtaposed to the cathode 20a and the anode 20b.

In the present variation, the first dielectric pipe 23a and the second dielectric pipe 23b are disposed upstream from the cathode 20a and the anode 20b along the flow of the laser gas. The third dielectric pipe 23c and the fourth dielectric pipe 23d are disposed downstream from the cathode 20a and the anode 20b along the flow of the laser gas.

In the present variation, the first insulating holder 40a has holes 45a and 46a formed at the one surface thereof in addition to the holes 41a and 42a and a groove 47a formed at the other surface thereof in addition to the groove 43a, as shown in FIG. 17. The holes 45a and 46a and the groove 47a are configured in the same manner as the holes 41a and 42a and the groove 43a.

In the present variation, the second insulating holder 40b has holes 45b and 46b formed at the one surface thereof in addition to the holes 41b and 42b and a groove 47b formed at the other surface thereof in addition to the groove 43b, as shown in FIG. 18. The holes 45b and 46b and the groove 47b are configured in the same manner as the holes 41b and 42b and the groove 43b.

One end of the third dielectric pipe 23c is fitted into the hole 45a of the first insulating holder 40a, and the other end of the third dielectric pipe 23c is fitted into the hole 45b of the second insulating holder 40b. One end of the fourth dielectric pipe 23d is fitted into the hole 46a of the first insulating holder 40a, and the other end of the fourth dielectric pipe 23d is fitted into the hole 46b of the second insulating holder 40b.

A portion of a preliminary ionization inner electrode 50 is inserted into the groove 47a of the first insulating holder 40a. The preliminary ionization inner electrode 50 is configured in the same manner as the preliminary ionization inner electrode 24, and includes a third preliminary ionization electrode 50a disposed in the inner space of the third dielectric pipe 23c and a fourth preliminary ionization electrode 50b disposed in the inner space of the fourth dielectric pipe 23d. The third preliminary ionization electrode 50a and the fourth preliminary ionization electrode 50b are connected to each other at the ends located on the same side. A portion where the third preliminary ionization electrode 50a and the fourth preliminary ionization electrode 50b are connected to each other and which extends in the Y direction is inserted into the groove 47a.

In the present variation, although four dielectric pipes are provided, the four dielectric pipes are held by the first insulating holder 40a and the second insulating holder 40b as in the first embodiment, so that there is no increase in the number of parts. The configuration suppresses the positional shift between the cathode 20a and the ultraviolet light generation region obliquely facing the cathode 20a and the positional shift between the anode 20b and the ultraviolet light generation region obliquely facing the anode 20b also in the downstream region along the flow of the laser gas. As described above, according to the present variation, even when four dielectric pipes are provided, the intensity distribution characteristics of the pulse laser light PL do not deteriorate.

Note that the present variation may be applied to the laser chamber apparatus 3 according to the first variation. That is, the four dielectric pipes may be provided in the laser chamber apparatus 3 according to the first variation.

### 3. SECOND EMBODIMENT

### 3.1 Configuration and Operation

A second embodiment of the present disclosure will be described. A gas laser apparatus 2 according to the second embodiment is configured in the same manner as the gas laser apparatus 2 according to the first embodiment except the laser chamber apparatus 3 is configured differently.

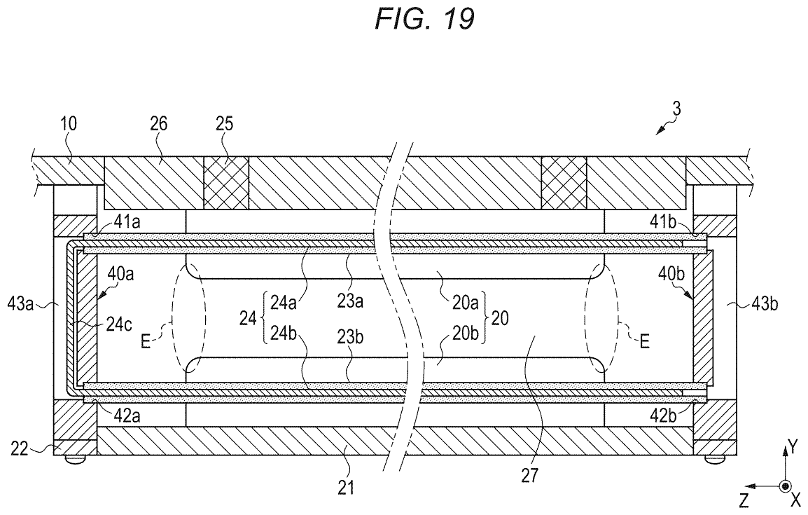

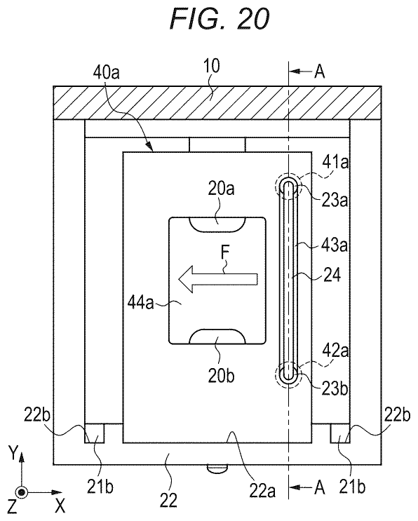

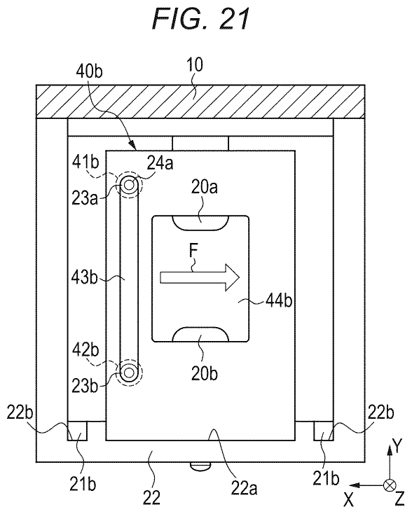

FIG. 19 is a cross-sectional view showing the configuration of a laser chamber apparatus 3 according to the second embodiment. FIG. 20 shows the laser chamber apparatus 3 according to the second embodiment viewed from the output coupling mirror 16 side. FIG. 21 shows the laser chamber apparatus 3 according to the second embodiment viewed from the line narrowing module 15 side. Note that FIG. 19 shows the cross-section taken along the line A-A in FIG. 20.

In the present embodiment, the first insulating holder 40a and the second insulating holder 40b are held by a pair of electrically conductive holding frames 22. A recess 22a is formed in each of the pair of electrically conductive holding frames 22, as shown in FIGS. 19 and 20. The first insulating holder 40a and the second insulating holder 40b are each so disposed that the bottom thereof is fitted into the recess 22a. The first insulating holder 40a and the second insulating holder 40b are configured in the same manner as in the first embodiment. Note in the present embodiment that the electrically conductive holding frames 22 and the ground plate 21 correspond to the “electrically conductive holder” according to the technology of the present disclosure.

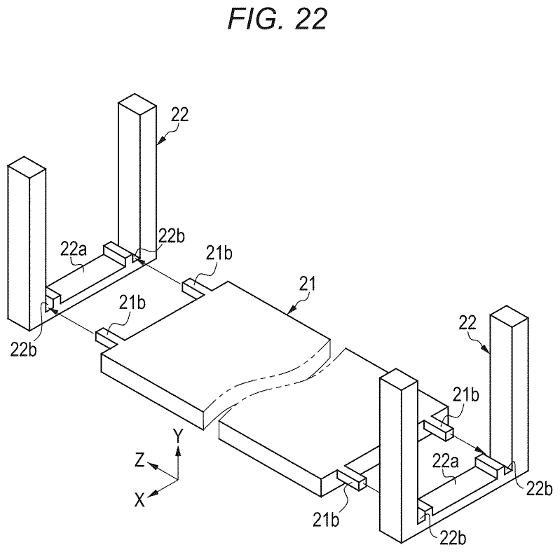

FIG. 22 shows that a ground plate 21 according to the second embodiment is connected to the pair of electrically conductive holding frames 22. In the present embodiment, two protrusions 21b are provided at each of the end surfaces of the ground plate 21 in the direction in which it extends. The electrically conductive holding frames 22 are each provided on both sides of the recess 22a with grooves 22b, into which the protrusions 21b are fitted. The ground plate 21 is connected to each of the electrically conductive holding frames 22 with the two protrusions 21b fitted into the two grooves 22b.

The recesses 22a intersect with an imaginary YZ plane, which passes through the anode 20b, in the X direction, as shown in FIGS. 20 to 22. The bottom surface of each of the recesses 22a is not limited to a planar surface, and may be curved in an arcuate shape. In this case, the bottom surface of each of the first insulating holder 40a and the second insulating holder 40b may be curved in an arcuate shape so as to be fitted to the recess 22a.

The operation of the gas laser apparatus 2 according to the present embodiment is the same as the operation of the gas laser apparatus 2 according to Comparative Example.

### 3.2 Advantages

In the present embodiment, the recesses 22a formed in the pair of electrically conductive holding frames 22 intersect with the imaginary YZ plane, which passes through the anode 20b, in the X direction. Only fitting the first insulating holder 40a and the second insulating holder 40b into the recesses 22a therefore allows the first dielectric pipe 23a and the second dielectric pipe 23b to be positioned with high precision with respect to the cathode 20a and the anode 20b.

In the present embodiment, the first insulating holder 40a and the second insulating holder 40b are held by the pair of electrically conductive holding frames 22. Therefore, in the present embodiment, the first insulating holder 40a and the second insulating holder 40b can be disposed at a distance from the cathode 20a and the anode 20b, as compared with the first embodiment. That is, in the present embodiment, the first dielectric pipe 23a and the second dielectric pipe 23b can be made longer than the cathode 20a and the anode 20b.

As described above, even when the first insulating holder 40a and the second insulating holder 40b are disposed at positions separate from the cathode 20a and the anode 20b, the aforementioned configuration of the present embodiment allows the first dielectric pipe 23a and the second dielectric pipe 23b to be positioned with high precision. The intensity distribution characteristics of the pulse laser light PL therefore do not deteriorate.

Furthermore, according to the present embodiment, since the lengths of the first dielectric pipe 23a and the second dielectric pipe 23b can be increased, the preliminary ionization of the laser gas in discharge regions E at the ends of the cathode 20a and the anode 20b shown in FIG. 19 is stabilized.

### 3.3 Variations

Variations of the second embodiment will be described below. The following variations each differ from the second embodiment only in the configuration of the laser chamber apparatus 3.

### 3.3.1 First Variation

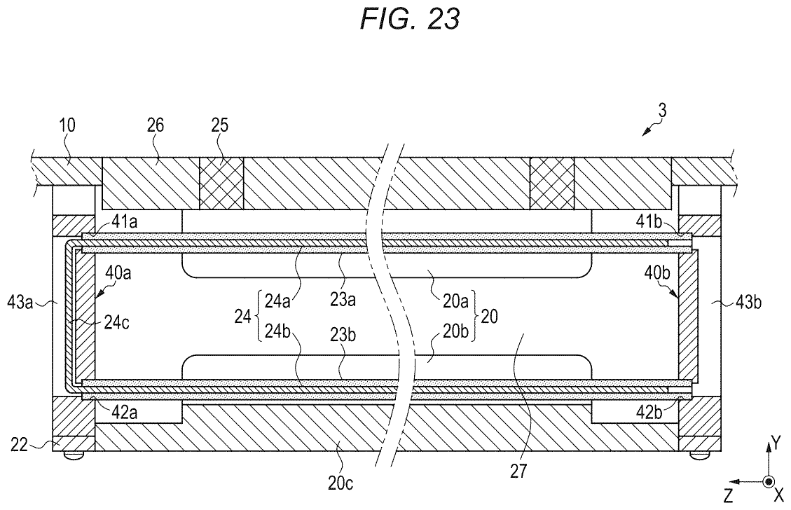

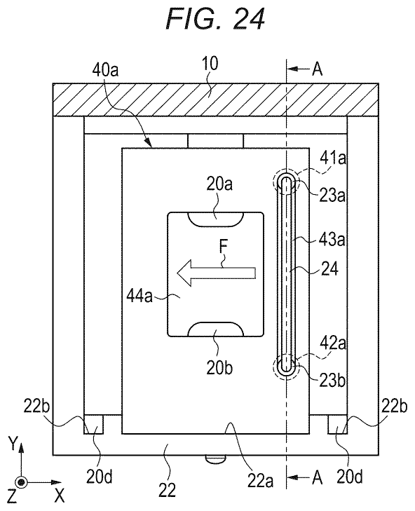

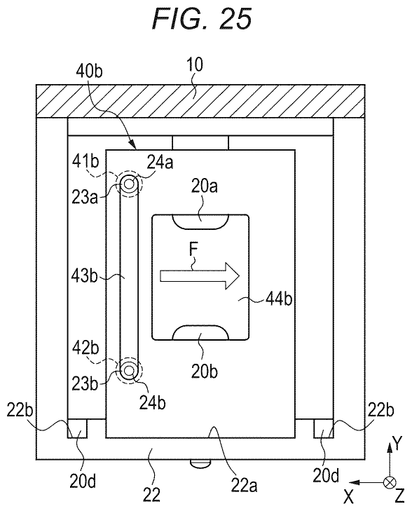

FIG. 23 is a cross-sectional view showing the configuration of a laser chamber apparatus 3 according to a first variation of the second embodiment. FIG. 24 shows the laser chamber apparatus 3 according to the first variation of the second embodiment viewed from the output coupling mirror 16 side. FIG. 25 shows the laser chamber apparatus 3 according to the first variation of the second embodiment viewed from the line narrowing module 15 side. Note that FIG. 23 shows the cross-section taken along the line A-A in FIG. 24.

The laser chamber apparatus 3 according to the present variation is configured in the same manner as the laser chamber apparatus 3 according to the second embodiment except that the ground plate 21 is replaced with the base section 20c of the anode 20b. The anode 20b and the base section 20c form a single unitary structure, as in the first modification of the first embodiment.

In the present variation, the first insulating holder 40a and the second insulating holder 40b are held by the pair of electrically conductive holding frames 22, as in the second embodiment. Specifically, the first insulating holder 40a and the second insulating holder 40b are fitted into the recesses 22a of the electrically conductive holding frames 22. Note in the present variation that the electrically conductive holding frames 22 and the base section 20c correspond to the “electrically conductive holder” according to the technology of the present disclosure.

Two protrusions 20d are provided at each of the end surfaces of the base section 20c in the direction in which it extends, as in the case of the ground plate 21 in the second embodiment. The base section 20c is connected to each of the electrically conductive holding frames 22 with the two protrusions 20d fitted into the two grooves 22b.

In the present variation, since the ground plate 21 is not provided, there are no dimensional errors due to the tolerances of the ground plate 21. The first dielectric pipe 23a and the second dielectric pipe 23b can therefore be positioned with higher precision, so that the intensity distribution characteristics of the pulse laser light PL are further improved.

### 3.3.2 Second Variation

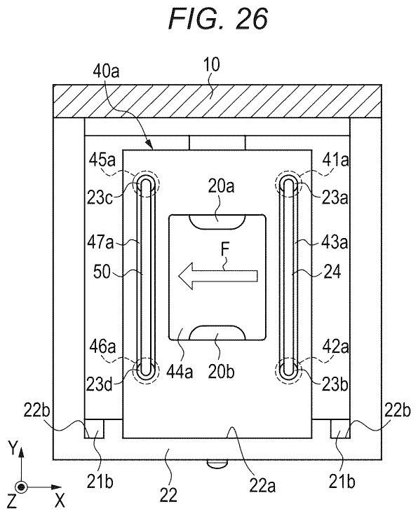

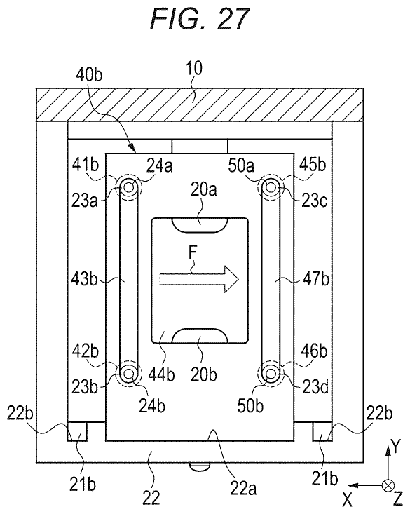

FIG. 26 shows a laser chamber apparatus 3 according to a second variation of the second embodiment viewed from the output coupling mirror 16 side. FIG. 27 shows the laser chamber apparatus 3 according to the second variation of the second embodiment viewed from the line narrowing module 15 side.

In the present variation, in addition to the first dielectric pipe 23a and the second dielectric pipe 23b, the third dielectric pipe 23c and the fourth dielectric pipe 23d are provided in the chamber 10. The third dielectric pipe 23c and the fourth dielectric pipe 23d are configured in the same manner as in the second variation of the first embodiment.

In the present variation, the first insulating holder 40a has the holes 45a and 46a formed at the one surface thereof in addition to the holes 41a and 42a and the groove 47a formed at the other surface thereof in addition to the groove 43a. The second insulating holder 40b has the holes 45b and 46b formed at the one surface thereof in addition to the holes 41b and 42b and the groove 47b formed at the other surface thereof in addition to the groove 43b. The first insulating holder 40a and the second insulating holder 40b are configured in the same manner as in the second variation of the first embodiment.

The present variation provides advantages that are the same as those provided by the second variation of the first embodiment. Note that the present variation may be applied to the laser chamber apparatus 3 according to the first variation of the second embodiment. That is, the four dielectric pipes may be provided in the laser chamber apparatus 3 according to the first variation of the second embodiment.

### 4. THIRD EMBODIMENT

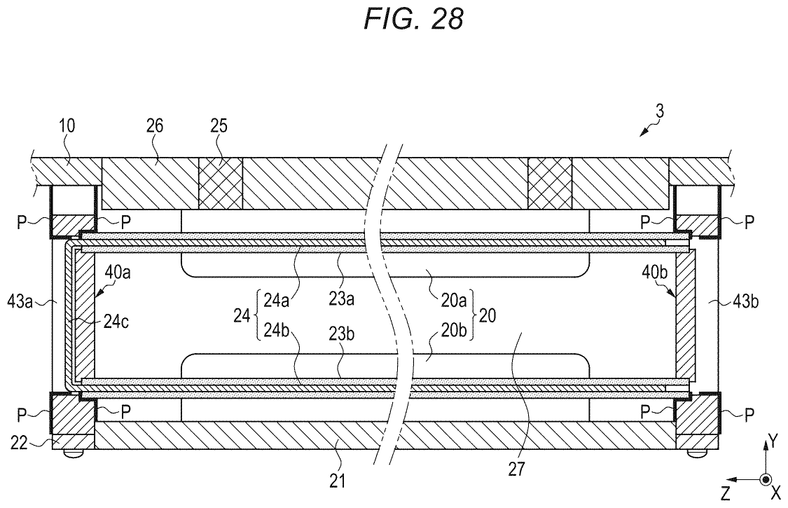

An embodiment that allows suppression of abnormal discharge will next be described. For example, in the laser chamber apparatus 3 according to the second embodiment, when the pressure of the laser gas in the chamber 10 is increased to increase the intensity of the output laser, abnormal discharge may occur during the preliminary ionization, as shown in FIG. 28. Specifically, abnormal discharge occurs between the preliminary ionization inner electrode 24 and metal elements that surround the preliminary ionization inner electrode 24 and differ therefrom in potential. For example, the abnormal discharge occurs when a current flows from the preliminary ionization inner electrode 24 along the surfaces of the first insulating holder 40a and the second insulating holder 40b and along paths P, such as those shown in FIG. 28, toward the ground plate 21 and the chamber 10. The discharge is called creeping discharge.

When the abnormal discharge occurs, the potential difference between the preliminary ionization inner electrode 24 and the preliminary ionization outer electrode varies, which causes variation in the preliminary ionization of the laser gas in the discharge space 27, resulting in deterioration of the intensity distribution characteristics of the pulse laser light PL. The abnormal discharge can be suppressed by increasing the lengths of the paths P shown in FIG. 28, that is, the creeping distance.

### 4.1 Configuration and Operation

A third embodiment of the present disclosure will be described. A gas laser apparatus 2 according to the third embodiment is configured in the same manner as the gas laser apparatus 2 according to the first embodiment except the laser chamber apparatus 3 is configured differently.

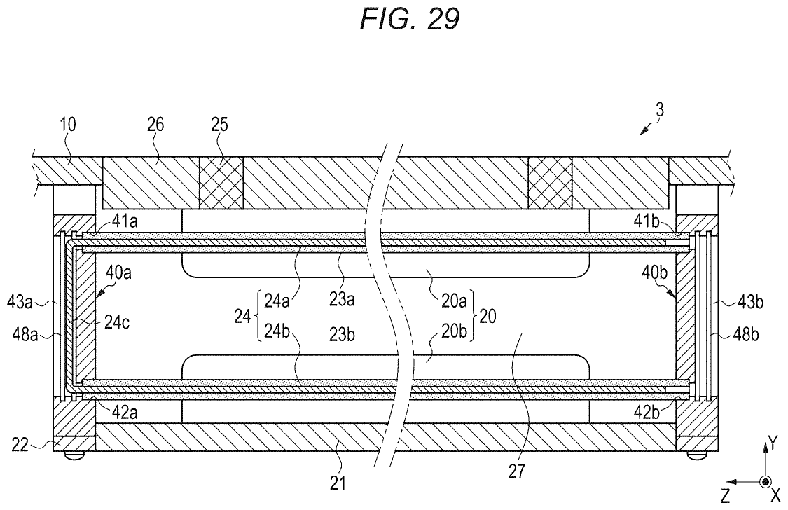

FIG. 29 is a cross-sectional view showing the configuration of the laser chamber apparatus 3 according to the third embodiment. The laser chamber apparatus 3 according to the present embodiment is configured in the same manner as the laser chamber apparatus 3 according to the second embodiment except that the first insulating holder 40a and the second insulating holder 40b are configured differently.

In the present embodiment, a surface of a first insulating holder 40a has a recessed and protruding structure 48a. Similarly, a surface of a second insulating holder 40b has a recessed and protruding structure 48b. Specifically, the recessed and protruding structure 48a is formed at the inner surface of the groove 43a. The recessed and protruding structure 48b is formed at the inner surface of the groove 43b.

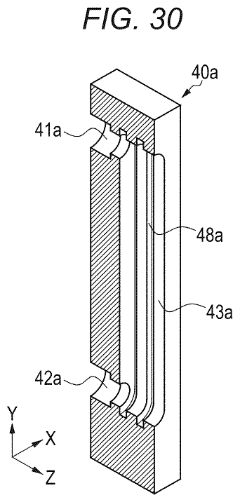

FIG. 30 is a cross-sectional view of the first insulating holder 40a taken along the groove 43a. The recessed and protruding structure 48a is so formed that the inner surface of the groove 43a is recessed and protruding in the Z direction. The thus formed recessed and protruding structure 48a increases the creeping distance. The same applies to the configuration of the recessed and protruding structure 48b.

The recessed and protruding structure 48a may instead be formed at a surface of the first insulating holder 40a other than the inner surface of the groove 43a. Similarly, the recessed and protruding structure 48b may be formed at a surface of the second insulating holder 40b other than the inner surface of the groove 43b.

The operation of the gas laser apparatus 2 according to the present embodiment is the same as the operation of the gas laser apparatus 2 according to Comparative Example.

### 4.2 Advantages

According to the present embodiment, since the creeping distance increases, the abnormal discharge is suppressed even when the pressure of the laser gas is increased. Highly intense pulse laser light PL can therefore be output without deterioration of the intensity distribution thereof.

### 4.3 Variations

Variations of the third embodiment will be described below. The following variations differ from the third embodiment only in the configurations of the first insulating holder 40a and the second insulating holder 40b.

### 4.3.1 First Variation

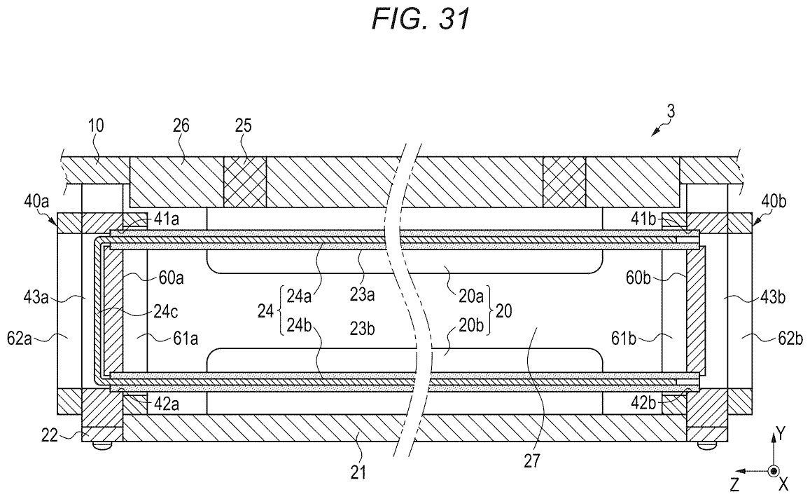

FIG. 31 is a cross-sectional view showing the configuration of a laser chamber apparatus 3 according to a first variation of the third embodiment. In the present variation, a first insulating holder 40a is configured with a body section 60a and overhanging sections 61a and 62a. Similarly, a second insulating holder 40b is configured with a body section 60b and overhanging sections 61b and 62b.

The body section 60a is configured in the same manner as the first insulating holder 40a according to the first embodiment. Note that the groove 43a of the body section 60a may be provided with the recessed and protruding structure 48a, as in the third embodiment. Similarly, the body section 60b is configured in the same manner as the second insulating holder 40b according to the first embodiment. Note that the groove 43b of the body section 60b may be provided with the recessed and protruding structure 48b, as in the third embodiment.

FIG. 32 is a perspective view showing the configuration of the first insulating holder 40a according to the first variation of the third embodiment. The overhanging sections 61a and 62a overhang from the outer circumference of the body section 60a in the Z direction. The overhanging section 61a overhangs from the body section 60a toward one side, and the overhanging section 62a overhangs from the body section 60a toward the other side. The body section 60a and the overhanging sections 61a and 62a may be a unitary structure. The second insulating holder 40b is configured in the same manner as the first insulating holder 40a.

In the present variation, since the first insulating holder 40a and the second insulating holder 40b include the overhanging sections 61a and 62a and the overhanging sections 61b and 62b, respectively, the creeping distance increases. The same advantages as those provided by the third embodiment are therefore provided.

### 4.3.2 Second Variation

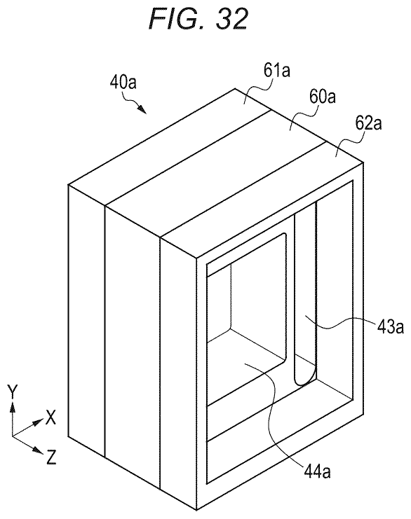

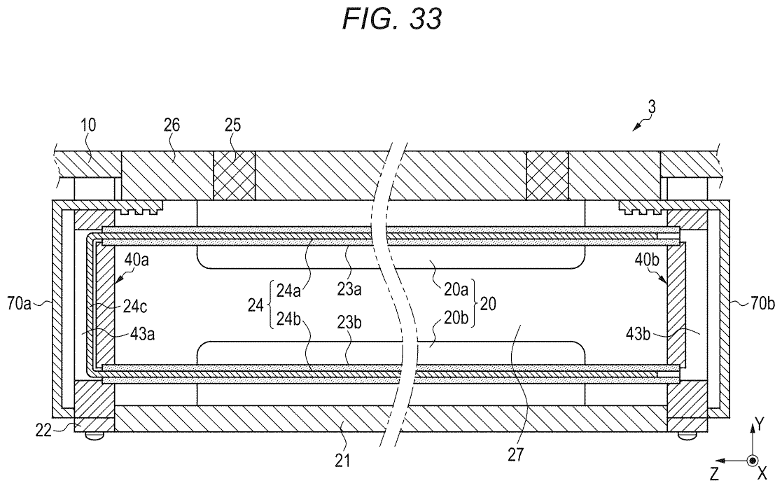

FIG. 33 is a cross-sectional view showing the configuration of a laser chamber apparatus 3 according to a second variation of the third embodiment. In the present variation, an insulating cover 70a, which covers a portion of the surface of the first insulating holder 40a, is attached to the first insulating holder 40a. Similarly, an insulating cover 70b, which covers a portion of the surface of the second insulating holder 40b, is attached to the second insulating holder 40b. The covers 70a and 70b are attached to regions including the abnormal discharge paths P described above. The material of the covers 70a and 70b is preferably a ceramic material such as highly insulating alumina.

The first insulating holder 40a and the second insulating holder 40b are configured in the same manner as in the first embodiment. Note that the grooves 43a and 43b may be provided with the recessed and protruding structures 48a and 48b, respectively, as in the third embodiment.

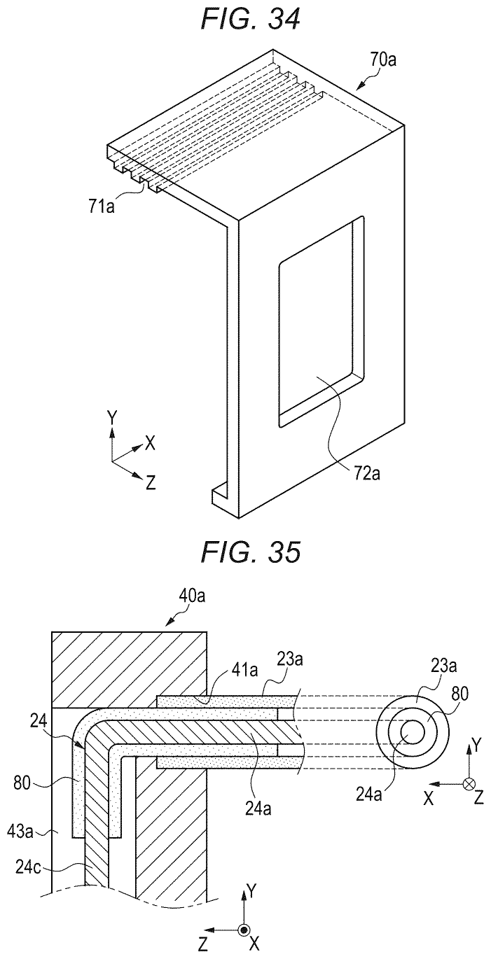

FIG. 34 is a perspective view showing the configuration of the cover 70a. The cover 70a is configured to cover the side surface and the upper surface of the first insulating holder 40a, which face the chamber 10. An opening 72a, via which the pulse laser light PL passes, is formed in the cover 70a.

Furthermore, the cover 70a has a recessed and protruding structure 71a formed at the inner surface of an upper portion where the abnormal discharge is likely to occur. The recessed and protruding structure 71a is formed by causing a portion of the inner surface of the upper portion of the cover 70a to be recessed and protruding in the Z direction. The recessed and protruding structure 71a is not necessarily formed at the inner surface of the upper portion of the cover 70a, and may be formed at another surface of the cover 70a. The cover 70b is configured in the same manner as the cover 70a.

In the present variation, since the covers 70a and 70b are attached to the first insulating holder 40a and the second insulating holder 40b, respectively, the creeping distance increases. The same advantages as those provided by the third embodiment are therefore provided.

### 4.3.3 Third Variation

In the third embodiment and the variations of the third embodiment, although the abnormal discharge is suppressed by increasing the creeping distance, the portions of the preliminary ionization inner electrode 24 where the abnormal discharge is likely to occur may be covered with insulators.

FIG. 35 is a cross-sectional view showing a portion of the first insulating holder 40a. In the present variation, the corners of the preliminary ionization inner electrode 24 are covered with cylindrical insulators 80. Specifically, end portions of the first preliminary ionization electrode 24a and the second preliminary ionization electrode 24b are covered with the insulators 80. The material of the insulators 80 is preferably a ceramic material such as highly insulating alumina.

The insulators 80 each have a nested structure. A portion of one of the insulators 80 is inserted into the space between the first preliminary ionization electrode 24a and the first dielectric pipe 23a at an end portion of the first preliminary ionization electrode 24a. A portion of the other insulator 80 is inserted between the space between the second preliminary ionization electrode 24b and the second dielectric pipe 23b at an end portion of the second preliminary ionization electrode 24b.

In the present variation, since the portions of the preliminary ionization inner electrode 24, where the abnormal discharge is likely to occur, are covered with the insulators 80, the abnormal discharge can be suppressed.

The configurations that suppress the abnormal discharge described in the third embodiment and the variations of the third embodiment can also be applied to the first embodiment, the variations of the first embodiment, the second embodiment, and the variations of the second embodiment.

### 5. OTHER VARIATIONS

In each of the embodiments and the variations thereof described above, the first dielectric pipe 23a and the second dielectric pipe 23b are positioned in the Z direction with the end surfaces thereof being in contact with the steps inside the respective holes of the first insulating holder 40a and the second insulating holder 40b. Instead, a step may be provided at an end portion of each of the first dielectric pipe 23a and the second dielectric pipe 23b, and the first dielectric pipe 23a and the second dielectric pipe 23b may be positioned in the Z direction by causing the step to come into contact with the corner of the corresponding hole.

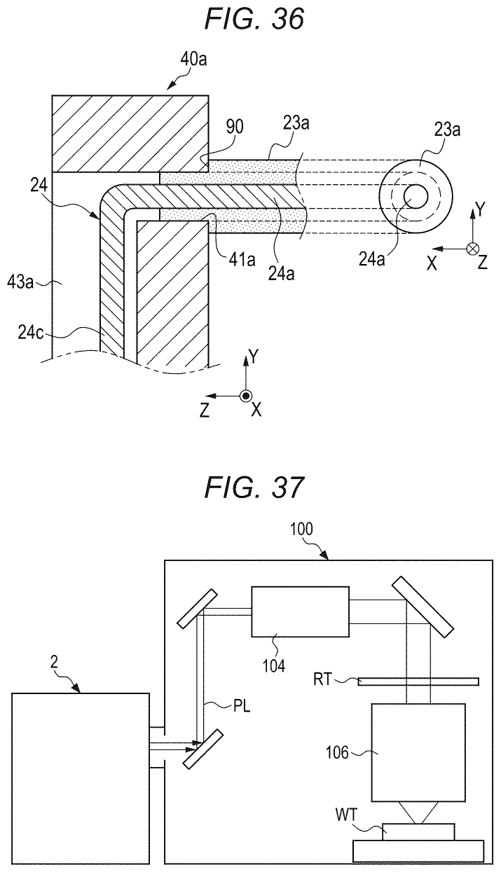

FIG. 36 is a cross-sectional view showing a portion of the first insulating holder 40a. In the present variation, a step 90 is formed at an end portion of the first dielectric pipe 23a. In the present variation, no step is formed in the hole 41a. The first dielectric pipe 23a is positioned in the Z direction with the step 90 being in contact with the corner of the hole 41a. The second insulating holder 40b and the second dielectric pipe 23b are configured in the same manner.

Furthermore, in each of the embodiments and the variations thereof described above, an excimer laser apparatus is presented as the gas laser apparatus 2 by way of example, and the gas laser apparatus 2 may instead, for example, be an F₂ laser apparatus using a laser gas containing a fluorine gas and a buffer gas.

### 6. ELECTRONIC DEVICE MANUFACTURING METHOD

FIG. 37 schematically shows an example of the configuration of the exposure apparatus 100. The exposure apparatus 100 includes an illumination optical system 104 and a projection optical system 106. The illumination optical system 104 illuminates a reticle pattern of a reticle that is not shown but is placed on a reticle stage RT, for example, with the pulse laser light PL having entered the illumination optical system 104 from the gas laser apparatus 2. The projection optical system 106 performs reduction projection on the pulse laser light PL having passed through the reticle to bring the pulse laser light PL into focus at a workpiece that is not shown but is placed on a workpiece table WT. The workpiece is a photosensitive substrate onto which a photoresist has been applied, such as a semiconductor wafer.

The exposure apparatus 100 synchronously translates the reticle stage RT and the workpiece table WT to expose the workpiece to the pulse laser light PL having reflected the reticle pattern. Semiconductor devices can be manufactured by transferring the reticle pattern onto the semiconductor wafer in the exposure step described above and then carrying out multiple other steps. The semiconductor devices are an example of the “electronic devices” in the present disclosure.

Note that the gas laser apparatus 2 does not necessarily manufacture electronic devices, and can also be used to perform laser processing such as drilling.

The above description is intended not to be limiting but merely to be illustrative. Therefore, it would be obvious to those skilled in the art that various modifications to the embodiments of the present disclosure would be possible without departing from the spirit and the scope of the appended claims.

The terms used throughout the present specification and the appended claims should be interpreted as non-limiting terms. For example, the term “include” or “included” should be interpreted as “is not limited to what is described as included”. The term “have” should be interpreted as “is not limited to what is described as having”. Furthermore, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A laser chamber apparatus configured to generate laser light by exciting a preliminarily ionized laser gas by discharge, the laser chamber apparatus comprising:
a chamber configured to house a laser gas;
a first discharge electrode disposed in the chamber;
a second discharge electrode disposed in the chamber so as to face the first discharge electrode, the first discharge electrode and the second discharge electrode being configured to excite the laser gas by the discharge;
an electrically conductive holder that holds the first discharge electrode;
a first dielectric pipe disposed along the first discharge electrode;
a second dielectric pipe facing the first dielectric pipe, the second dielectric pipe being disposed along the second discharge electrode;
a first preliminary ionization electrode disposed in an inner space of the first dielectric pipe;
a second preliminary ionization electrode disposed in an inner space of the second dielectric pipe;
a first insulating holder disposed in the electrically conductive holder, the first insulating holder holding one-side end portions of the first dielectric pipe and the second dielectric pipe; and
a second insulating holder disposed in the electrically conductive holder, the second insulating holder holding another-side end portions of the first dielectric pipe and the second dielectric pipe.

2. The laser chamber apparatus according to claim 1, wherein
the first preliminary ionization electrode is connected to the second preliminary ionization electrode.

3. The laser chamber apparatus according to claim 2, wherein
a groove is formed in the first insulating holder, and
a portion where the first preliminary ionization electrode and the second preliminary ionization electrode are connected to each other is disposed in the groove.

4. The laser chamber apparatus according to claim 1, wherein
the first insulating holder is made of a ceramic material.

5. The laser chamber apparatus according to claim 4, wherein
the ceramic material is alumina or zirconium oxide.

6. The laser chamber apparatus according to claim 1, wherein
the first dielectric pipe and the second dielectric pipe are made of alumina or sapphire.

7. The laser chamber apparatus according to claim 1, wherein
an end portion of the first dielectric pipe and an end portion of the second dielectric pipe are fitted to the first insulating holder.

8. The laser chamber apparatus according to claim 7, wherein
the first insulating holder has two holes, and
the end portion of the first dielectric pipe is fitted into one of the two holes, and the end portion of the second dielectric pipe is fitted into another of the two holes.

9. The laser chamber apparatus according to claim 1, wherein
the electrically conductive holder extends in a longitudinal direction of the first discharge electrode, and
the first insulating holder and the second insulating holder are disposed at both end portions of the electrically conductive holder in a direction in which the electrically conductive holder extends.

10. The laser chamber apparatus according to claim 1, wherein
the electrically conductive holder is a base portion of the first discharge electrode.

11. The laser chamber apparatus according to claim 1, further comprising:
a third dielectric pipe having an inner space in which a third preliminary ionization electrode is disposed; and
a fourth dielectric pipe having an inner space in which a fourth preliminary ionization electrode is disposed,
wherein the first insulating holder holds one-side end portions of the third dielectric pipe and the fourth dielectric pipe, and
the second insulating holder holds another-side end portions of the third dielectric pipe and the fourth dielectric pipe.

12. The laser chamber apparatus according to claim 1, wherein
a step is formed at an end portion of each of the first dielectric pipe and the second dielectric pipe.

13. The laser chamber apparatus according to claim 1, wherein
the first insulating holder has a surface at which a recessed and protruding structure is formed.

14. The laser chamber apparatus according to claim 1, wherein
the first insulating holder includes an overhanging section that overhangs from an outer circumference of the first insulating holder.

15. The laser chamber apparatus according to claim 1, further comprising
a cover configured to cover a portion of a surface of the first insulating holder.

16. The laser chamber apparatus according to claim 15, wherein
the cover has a recessed and protruding structure at a surface of the cover.

17. The laser chamber apparatus of claim 1, further comprising
a cylindrical insulator configured to cover a portion of the first or second preliminary ionization electrode.

18. The laser chamber apparatus according to claim 1, wherein
the first insulating holder and the second insulating holder are each a unitary structure.

19. A gas laser apparatus comprising:
a laser chamber apparatus configured to generate laser light by exciting a preliminarily ionized laser gas by discharge,
the laser chamber apparatus including
a chamber configured to house a laser gas,
a first discharge electrode disposed in the chamber,
a second discharge electrode disposed in the chamber so as to face the first discharge electrode, the first discharge electrode and the second discharge electrode being configured to excite the laser gas by the discharge,
an electrically conductive holder that holds the first discharge electrode,
a first dielectric pipe disposed along the first discharge electrode,
a second dielectric pipe facing the first dielectric pipe, the second dielectric pipe being disposed along the second discharge electrode,
a first preliminary ionization electrode disposed in an inner space of the first dielectric pipe,
a second preliminary ionization electrode disposed in an inner space of the second dielectric pipe,
a first insulating holder disposed in the electrically conductive holder, the first insulating holder holding one-side end portions of the first dielectric pipe and the second dielectric pipe, and
a second insulating holder disposed in the electrically conductive holder, the second insulating holder holding another-side end portions of the first dielectric pipe and the second dielectric pipe.

20. An electronic device manufacturing method comprising:
generating laser light by using a gas laser apparatus including a laser chamber apparatus;
outputting the laser light to an exposure apparatus; and
exposing a photosensitive substrate to the laser light in the exposure apparatus to manufacture electronic devices,
the laser chamber apparatus including
a chamber configured to house a laser gas,
a first discharge electrode disposed in the chamber,
a second discharge electrode disposed in the chamber so as to face the first discharge electrode, the first discharge electrode and the second discharge electrode being configured to excite the laser gas by the discharge,
an electrically conductive holder that holds the first discharge electrode,
a first dielectric pipe disposed along the first discharge electrode,
a second dielectric pipe facing the first dielectric pipe, the second dielectric pipe being disposed along the second discharge electrode,
a first preliminary ionization electrode disposed in an inner space of the first dielectric pipe,
a second preliminary ionization electrode disposed in an inner space of the second dielectric pipe,
a first insulating holder disposed in the electrically conductive holder, the first insulating holder holding one-side end portions of the first dielectric pipe and the second dielectric pipe, and
a second insulating holder disposed in the electrically conductive holder, the second insulating holder holding another-side end portions of the first dielectric pipe and the second dielectric pipe.
